(19) United States
(12) Patent Application Publication
(10) Pub. No.: US 2024/0218262 A1
(43) Pub. Date: Jul. 4, 2024

(54) PROCESS FOR BIORENEWABLE LIGHT PARAFFINIC KEROSENE AND SUSTAINABLE AVIATION FUEL

(71) Applicant: REG SYNTHETIC FUELS, LLC, Ames, IA (US)

(72) Inventors: Ramin Abhari, Bixby, OK (US); Martin Haverly, Ames, IA (US); Mason Berg, Altoona, IA (US); David A. Slade, Ames, IA (US); H. Lynn Tomlinson, Leonard, OK (US); Trevor Fisher, Bixby, OK (US)

(73) Assignee: REG SYNTHETIC FUELS, LLC, Ames, IA (US)

(21) Appl. No.: 18/563,045

(22) PCT Filed: Jun. 1, 2022
(86) PCT No.: PCT/US2022/031827

§ 371 Date: Nov. 21, 2023

Related U.S. Application Data
(60) Provisional application No. 63/195,665, filed on Jun. 1, 2021.

(51) Int. Cl. C10G 3/00; C10G 65/04; C10L 1/02

(52) U.S. Cl. CPC C10G 3/50; C10G 3/46; C10G 65/043; C10L 1/026; C10G 2300/1011; C10G 2400/04; C10G 2400/08; C10L 2200/0469; C10L 2270/026; C10L 2270/04

(57) ABSTRACT

The present disclosure relates to biofuels, and more particularly, to biomass-based kerosene and aviation turbine fuels. In an aspect, a method is disclosed for producing a light paraffinic kerosene (LPK) where the method includes hydrotreating a biorenewable feedstock to yield a heavy hydrotreater fraction comprising C14-C24 n-paraffins; hydroisomerizing and hydrocracking the heavy hydrotreater fraction with a hydroisomerization catalyst under conditions yielding a hydroisomerizer product that includes a heavy hydroisomerizer fraction and the LPK; and separating the LPK from the hydroisomerizer product. The LPK provided by the method has an existent gum value of 7 mg/100 mL or less as measured according to IP 540 air evaporation method and further includes (a) a weight ratio of isoparaffins to n-paraffins of about 2:1 or greater, or (b) no detectable hydrocarbons with 14 or more carbon atoms as measured by gas chromatography, or (c) a weight ratio of isoparaffins to n-paraffins of about 2:1 or greater and no detectable hydrocarbons with 14 or more carbon atoms as measured by gas chromatography.

### CROSS-REFERENCE TO RELATED APPLICATIONS

This application claims the benefit of and priority to U.S. Provisional Appl. No. 63/195,665, filed Jun. 1, 2021, the entirety of which is herein incorporated by reference for any and all purposes.

### FIELD

The present technology relates to synthetic fuels, and more particularly, to biomass-based kerosene and aviation turbine fuels.

### SUMMARY

In an aspect, the present technology provides a method for producing a light paraffinic kerosene (LPK) where the method includes hydrotreating a biorenewable feedstock comprising C₁₄-C₂₄ fatty acids, fatty acid esters, and/or fatty acid glycerides to yield a heavy hydrotreater fraction comprising C₁₄-C₂₄ n-paraffins; hydroisomerizing and hydrocracking the heavy hydrotreater fraction with a hydroisomerization catalyst under conditions yielding a hydroisomerizer product that includes a heavy hydroisomerizer fraction and the LPK (where the LPK includes C₈-C₁₁ hydrocarbons; and separating the LPK from the hydroisomerizer product. The LPK of the method has an existent gum value of 7 mg/100 mL or less as measured according to IP 540 air evaporation method and further includes (a) a weight ratio of isoparaffins to n-paraffins of about 2:1 or greater, or (b) no detectable hydrocarbons with 14 or more carbon atoms as measured by gas chromatography, or (c) a weight ratio of isoparaffins to n-paraffins of about 2:1 or greater and no detectable hydrocarbons with 14 or more carbon atoms as measured by gas chromatography.

In a related aspect, a method of producing a sustainable aviation fuel (SAF) is provided that includes combining C₁₂-C₁₆ isoparaffins with an LPK produced by any embodiment of the method of the present technology for producing LPK. In a further related aspect, the present technology provides the SAF produced by the aforementioned method. In an aspect, the present technology provides an SAF composition that includes C₁₂-C₁₆ isoparaffins as well as an LPK produced by any embodiment of the method of the present technology for producing LPK.

In an aspect, the present technology provides a method for producing a biorenewable sustainable aviation fuel (SAF), where the method includes hydrotreating a biorenewable feedstock comprising C₁₄-C₂₄ fatty acids, fatty acid esters, and/or fatty acid glycerides to yield a heavy hydrotreater fraction comprising C₁₄-C₂₄ n-paraffins; hydroisomerizing and hydrocracking the heavy hydrotreater fraction with a hydroisomerization catalyst under conditions yielding a hydroisomerizer product comprising a heavy hydroisomerizer fraction and a light paraffinic kerosene (LPK) where the LPK includes C₈-C₁₁ hydrocarbons and a ratio of isoparaffins to n-paraffins of about 2:1 or greater; and separating a sustainable aviation fuel (SAF) from the hydroisomerizer product; where the SAF comprises at least a portion of the LPK; the LPK has an existent gum value of 7 mg/100 mL or less as measured according to IP 540 air evaporation method and further includes (a) a weight ratio of isoparaffins to n-paraffins of about 2:1 or greater, or (b) no detectable hydrocarbons with 14 or more carbon atoms as measured by gas chromatography, or (c) a weight ratio of isoparaffins to n-paraffins of about 2:1 or greater and no detectable hydrocarbons with 14 or more carbon atoms as measured by gas chromatography; and the SAF has an existent gum value of 7 mg/100 mL or less as measured according to IP 540 air evaporation method. In a related aspect, the present technology provides a biorenewable SAF produced according to any embodiment of the method of the present technology for producing biorenewable SAF.

### BRIEF DESCRIPTION OF THE DRAWINGS

FIG. 1 provides a schematic illustration of an exemplary process for producing LPK, according to embodiments.

FIG. 2 is a reproduction of GC peaks of the “gum” residue showing no peaks in the high molecular weight region, according to the working examples.

FIG. 3 is a reproduction of the overlay chromatograms of seven “gum” residues showing various C₁₄-C₂₂ paraffinic hydrocarbons, as discussed in the working examples.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term—for example, “about 10 weight %” would be understood to mean “9 weight % to 11 weight %.” It is to be understood that when “about” precedes a term, the term is to be construed as disclosing “about” the term as well as the term without modification by “about”—for example, “about 10 wt %” discloses “9 wt % to 11 wt %” as well as disclosing “10 wt %.”

The phrase “and/of” as used in the present disclosure will be understood to mean any one of the recited members individually or a combination of any two or more thereof—for example, “A, B, and/or C” would mean “A, B, C, A and B, A and C, B and C, or the combination of A, B, and C.”

As used herein and in the appended claims, singular articles such as “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

As used herein, “alkyl” groups include straight chain and branched alkyl groups, such as those having from 1 to 25 carbon atoms. Examples of straight chain alkyl groups include methyl, ethyl, n-propyl, n-butyl, n-pentyl, n-hexyl, n-heptyl, and n-octyl groups. Examples of branched alkyl groups include, but are not limited to, isopropyl, sec-butyl, t-butyl, neopentyl, and isopentyl groups. It will be understood that the phrase “Cₓ-C_{y} alkyl,” such as C₁-C₄ alkyl, means an alkyl group with a carbon number falling in the range from x to y.

Cycloalkyl groups include mono-, bi-, or tricyclic alkyl groups having from 3 to 12 carbon atoms in the ring(s). Cycloalkyl groups may be substituted with one or more alkyl groups or may be unsubstituted. Exemplary monocyclic cycloalkyl groups include, but not limited to, cyclopropyl, cyclobutyl, cyclopentyl, cyclohexyl, cycloheptyl, and cyclooctyl groups. In some embodiments, the cycloalkyl group has 3 to 8 ring members, whereas in other embodiments the number of ring carbon atoms range from 3 to 5, 3 to 6, or 3 to 7. Bi- and tricyclic ring systems include both bridged cycloalkyl groups and fused rings, such as, but not limited to, bicyclo[2.1.1]hexane, adamantyl, decalinyl, and the like. Representative substituted cycloalkyl groups may be mono-substituted or substituted more than once, such as, but not limited to, 2,2-, 2,3-, 2,4-2,5- or 2,6-disubstituted cyclohexyl groups.

Alkenyl groups include straight chain and branched chain alkyl groups as defined above, except that at least one double bond exists between two carbon atoms. Alkenyl groups have from 2 to 25 carbon atoms. An alkenyl group of any embodiment herein may have one, two, three, or four carbon-carbon double bonds. Examples of alkenyl groups include, but are not limited, to vinyl, allyl, —CH═CH(CH₃), —CH═C(CH₃)₂, —C(CH₃)═CH₂, —C(CH₃)═CH(CH₃), —C(CH₂CH₃)═CH₂, among others.

Cycloalkenyl groups include cycloalkyl groups as defined above, having at least one double bond between two carbon atoms. Cycloalkenyl groups may be substituted with one or more alkyl groups or may be unsubstituted. The cycloalkenyl group may have one, two, or three double bonds, but does not include aromatic compounds. Cycloalkenyl groups may have from 4 to 14 carbon atoms, 5 to 14 carbon atoms, 5 to 10 carbon atoms, or even 5, 6, 7, or 8 carbon atoms. Examples of cycloalkenyl groups include cyclohexenyl, cyclopentenyl, cyclohexadienyl, cyclobutadienyl, and cyclopentadienyl.

The term “aromatics” as used herein is synonymous with “aromates” and means both cyclic aromatic hydrocarbons that do not contain heteroatoms as well as heterocyclic aromatic compounds. The term includes monocyclic, bicyclic and polycyclic ring systems (collectively, such bicyclic and polycyclic ring systems are referred to herein as “polycyclic aromatics” or “polycyclic aromates”). The term also includes aromatic species with alkyl groups and cycloalkyl groups. Thus, aromatics include, but are not limited to, benzene, azulene, heptalene, phenylbenzene, indacene, fluorene, phenanthrene, triphenylene, pyrene, naphthacene, chrysene, anthracene, indene, indane, pentalene, and naphthalene, as well as alkyl and cycloalkyl substituted variants of these compounds. In some embodiments, aromatic species contains 6-14 carbons, and in others from 6 to 12 or even 6-10 carbon atoms in the ring portions of the groups. The phrase includes groups containing fused rings, such as fused aromatic-aliphatic ring systems (e.g., indane, tetrahydronaphthene, and the like).

“Oxygenates” as used herein means carbon-containing compounds containing at least one covalent bond to oxygen. Examples of functional groups encompassed by the term include, but are not limited to, carboxylic acids, carboxylates, acid anhydrides, aldehydes, esters, ethers, ketones, and alcohols, as well as heteroatom esters and anhydrides such as phosphate esters and phosphate anhydrides. Oxygenates may also be oxygen containing variants of aromatics, cycloparaffins, and paraffins as described herein.

The term “paraffins” as used herein means non-cyclic, branched or unbranched alkanes. An unbranched paraffin is an n-paraffin; a branched paraffin is an iso-paraffin (also referred to as an “isoparaffin”). “Cycloparaffins” are cyclic, branched or unbranched alkanes.

The term “paraffinic” as used herein means both paraffins and cycloparaffins as defined above as well as predominantly hydrocarbon chains possessing regions that are alkane, either branched or unbranched, with mono- or di-unsaturation (i.e., one or two double bonds).

Hydroprocessing as used herein describes the various types of catalytic reactions that occur in the presence of hydrogen without limitation. Examples of the most common hydroprocessing reactions include, but are not limited to, hydrogenation, hydrodesulfurization (HDS), hydrodenitrogenation (HDN), hydrotreating (HT), hydrocracking (HC), aromatic saturation or hydrodearomatization (HDA), hydrodeoxygenation (HDO), decarboxylation (DCO), hydroisomerization (HI), hydrodewaxing (HDW), hydrodemetallization (HDM), decarbonylation, methanation, and reforming. Depending upon the type of catalyst, reactor configuration, reactor conditions, and feedstock composition, multiple reactions can take place that range from purely thermal (i.e., do not require catalyst) to catalytic. In the case of describing the main function of a particular hydroprocessing unit, for example an HDO reaction system, it is understood that the HDO reaction is merely one of the predominant reactions that are taking place and that other reactions may also take place.

Pyrolysis is understood to mean thermochemical decomposition of carbonaceous material with little to no diatomic oxygen or diatomic hydrogen present during the thermochemical reaction. The optional use of a catalyst in pyrolysis is typically referred to as catalytic cracking, which is encompassed by the term as pyrolysis, and is not be confused with hydrocracking.

Hydrotreating (HT) involves the removal of elements from groups 3, 5, 6, and/or 7 of the Periodic Table from organic compounds. Hydrotreating may also include hydrodemetallization (HDM) reactions. Hydrotreating thus involves removal of heteroatoms such as oxygen, nitrogen, sulfur, and combinations of any two more thereof through hydroprocessing. For example, hydrodeoxygenation (HDO) is understood to mean removal of oxygen by a catalytic hydroprocessing reaction to produce water as a by-product; similarly, hydrodesulfurization (HDS) and hydrodenitrogenation (HDN) describe the respective removal of the indicated elements through hydroprocessing.

Hydrogenation involves the addition of hydrogen to an organic molecule without breaking the molecule into subunits. Addition of hydrogen to a carbon-carbon or carbon-oxygen double bond to produce single bonds are two nonlimiting examples of hydrogenation. Partial hydrogenation and selective hydrogenation are terms used to refer to hydrogenation reactions that result in partial saturation of an unsaturated feedstock. For example, vegetable oils with a high percentage of polyunsaturated fatty acids (e.g., linoleic acid) may undergo partial hydrogenation to provide a hydroprocessed product wherein the polyunsaturated fatty acids are converted to mono-unsaturated fatty acids (e.g., oleic acid) without increasing the percentage of undesired saturated fatty acids (e.g., stearic acid). While hydrogenation is distinct from hydrotreatment, hydroisomerization, and hydrocracking, hydrogenation may occur amidst these other reactions.

Hydrocracking (HC) is understood to mean the breaking of a molecule's carbon-carbon bond to form at least two molecules in the presence of hydrogen. Such reactions typically undergo subsequent hydrogenation of the resulting double bond.

Hydroisomerization (HI) is defined as the skeletal rearrangement of carbon-carbon bonds in the presence of hydrogen to form an isomer. Hydrocracking is a competing reaction for most HI catalytic reactions and it is understood that the HC reaction pathway, as a minor reaction, is included in the use of the term HI. Hydrodewaxing (HDW) is a specific form of hydrocracking and hydroisomerization designed to improve the low temperature characteristics of a hydrocarbon fluid.

It will be understood that if a composition is stated to include “Cₓ-C_{y} hydrocarbons,” such as C₇-C₁₂ n-paraffins, this means the composition includes one or more n-paraffins with a carbon number falling in the range from x to y. The phrase “C_{z}+” or “C_{z} plus” will be understood to include compounds with a carbon number of z or greater; likewise, the phrase “C_{w}−” or “C_{w} minus” will be understood to include compounds with a carbon number of w or less.

The phrase “at least a portion of” in regard to a composition means from about 1 wt. % to about 100 wt. % of the composition.

A “diesel fuel” in general refers to a fuel with a boiling point that falls in the range from about 150° C. to about 360° C. (the “diesel boiling range”).

A “gasoline” in general refers to a fuel for spark-ignition engines with a boiling point that falls in the range from about 30° C. to about 200° C.

A “biodiesel” as used herein refers to fatty acid C₁-C₄ alkyl esters produced by esterification and/or transesterification reactions between a C₁-C₄ alkyl alcohol and free fatty acids and/or fatty acid glycerides, such as described in U.S. Pat. Publ. No. 2016/0145536, incorporated herein by reference.

A “petroleum diesel” as used herein refers to diesel fuel produced from crude oil, such as in a crude oil refining facility and includes hydrotreated straight-run diesel, hydrotreated fluidized catalytic cracker light cycle oil, hydrotreated coker light gasoil, hydrocracked FCC heavy cycle oil, and combinations thereof. Similarly, a “petroleum-derived”compound or composition (e.g., a “petroleum-based feedstock”) refers to a compound or composition produced directly from crude oil or produced from components and/or feedstocks that ultimately were produced from crude oil and not biorenewable feedstocks (where biorenewable feedstocks are described more fully infra).

It is to be understood that a “volume percent” or “vol. %” of a component in a composition or a volume ratio of different components in a composition is determined at 60° F. based on the initial volume of each individual component, not the final volume of combined components.

Throughout this disclosure various publications, patents, patent applications, and published patent specifications are referenced by an identifying citation. The disclosures of these publications, patents, patent applications, and published patent specifications are hereby incorporated by reference into the present disclosure.

### The Present Technology

Hydroprocessing of fats, oils, and greases (FOG) for production of hydrocarbons, including Renewable Diesel and jet fuel, has been described in the prior art; e.g. U.S. Pat. Nos. 8,026,401, 7,968,757, and 7,846,323. The renewable jet fuel produced by hydroprocessing of FOG is also referred to as HEFA (hydroprocessed esters and fatty acids) and its specifications are provided in Annex A2 of ASTM D7566-17a. In reference to HEFA, hydroprocessing includes hydrotreating for conversion of fatty acid/esters to hydrocarbons composed mainly of normal paraffins, followed by hydroisomerization/hydrocracking of the n-paraffins to a mixture of iso-paraffins and n-paraffins.

ASTM D7566-17a also provides the specifications for other synthetic/renewable jet fuels, broadly referred to as Sustainable Aviation Fuels (SAF). These include Fischer-Tropsch hydroprocessed synthetic paraffinic kerosene (Annex A1), synthesized isoparaffins from hydroprocessed fermented sugars (Annex A3), and alcohol-to-jet synthetic paraffinic kerosene. (Annex A5). All these synthesized hydrocarbons are paraffins (alkanes) with virtually no aromatic hydrocarbon components. As a result, SAF has significantly lower particulate matter or soot emissions than conventional jet fuel.

In a 2018 webinar organized by the Commercial Alternative Aviation Fuel Initiative (CAAFI), the National Jet Fuels Combustion Program (NJFCP) reported on a few key hydrocarbon fuel properties that impact Lean Blow-Out (LBO). LBO is a measure of the lowest fuel flow to the turbine before the flame goes out. A good fuel will manage to keep the jet turbine engine running even at low flows (or low fuel-to-air ratios). The NJFCP team has determined that LBO correlates well with Derived Cetane Number (DCN). The best LBO performance was observed for fuels with DCN values above 55, preferably above 60. DCN is the cetane number derived by measuring ignition delay using the apparatus and methodology described in ASTM D6890 test method. DCN requires less sample for determining cetane number than the older D613 test method which relies on an actual diesel test engine. Although cetane number is a key fuel property for diesel engines, it is not believed to directly impact jet engine performance. As such, DCN may be regarded as an indirect indicator of the fuel chemistry that mitigates LBO.

NJFCP also highlighted results that showed lighter paraffinic jet fuels have better ignition properties (e.g. easier to ignite at very low temperatures) than conventional or heavier jet fuels. In addition to lower boiling range, lighter fuels generally have lower viscosities and surface tensions. These properties seem to help with low temperature ignition. NJFCP has seen strong correlation between this jet engine performance parameter and the fuel's T10, T20, T50 (i.e. the ASTM D86 10%, 20%, and 50% volume distillation temperatures) and low temperature viscosity values. The easiest to ignite fuel tested was one boiling in the 150-180 C range. The final boiling point (FBP) value of 180° C. is significantly lower than the 300° C. FBP specified for SAF in ASTM D7566.

In order to conform to ASTM D7566 specifications, a jet fuel must have an existent gum value of 7 mg/100 mL or less. The existent gum value is a measure of the fuel's thermo-oxidative stability, and may be measured according to the ASTM D381 test method (where steam is used as the stripping medium for jet fuel evaporation) or the IP 540 test method (where air may be used instead of steam). For example, peroxides formed from oxidation reactions can initiate polymerization and create gum-like residue. Existent gum is thus an indication of oxidation products (typically polymers) formed in the fuel. The existent gum test also shows heavy contaminants or particulate matter present in the fuel. In the art, it is understood that the test methods according to ASTM D381 and IP 540 are similar and therefore are expected to provide the same result within the indicated repeatability and reproducibility range for the test.

However, when the inventors of the present technology worked to produce from a biorenewable feedstock a Light Paraffinic Kerosene (LPK) with a boiling range no greater than 180° C. and a DCN of about 55 or greater, the LPK produced generally conformed to ASTM D7566 HEFA specifications (including density and flash point) but did not meet the required existent gum specification on a consistent basis. In particular, ASTM D381 and IP 540 provided different results for LPK where the IP 540 air evaporation method generally provided values above 7 mg/100 mL. Accordingly, the inventors discovered a need to produce LPK from a process including a biorenewable feedstock in order to ensure conformance with the existent gum specification as tested according to IP 540, as well as to produce SAF including such LPK.

Accordingly, in an aspect, the present technology provides a method for producing a light paraffinic kerosene (LPK) where the method includes hydrotreating a biorenewable feedstock comprising C₁₄-C₂₄ fatty acids, fatty acid esters, and/or fatty acid glycerides to yield a heavy hydrotreater fraction comprising C₁₄-C₂₄ n-paraffins; hydroisomerizing and hydrocracking the heavy hydrotreater fraction with a hydroisomerization catalyst under conditions yielding a hydroisomerizer product that includes a heavy hydroisomerizer fraction and the LPK (where the LPK includes C₈-C₁₁ hydrocarbons); and separating the LPK from the hydroisomerizer product. The LPK of the method has an existent gum value of 7 mg/100 mL or less as measured according to IP 540 air evaporation method and further includes (a) a weight ratio of isoparaffins to n-paraffins of about 2:1 or greater, or (b) no detectable hydrocarbons with 14 or more carbon atoms as measured by gas chromatography, or (c) a weight ratio of isoparaffins to n-paraffins of about 2:1 or greater and no detectable hydrocarbons with 14 or more carbon atoms as measured by gas chromatography.

In a related aspect, a method of producing a sustainable aviation fuel (SAF) is provided that includes combining C₁₂-C₁₆ isoparaffins with an LPK produced by any embodiment of the method of the present technology for producing LPK. In a further related aspect, the present technology provides the SAF produced by the aforementioned method. In an aspect, the present technology provides an SAF composition that includes C₁₂-C₁₆ isoparaffins as well as an LPK produced by any embodiment of the method of the present technology for producing LPK.

In an aspect, the present technology provides a method for producing a biorenewable sustainable aviation fuel (SAF), where the method includes hydrotreating a biorenewable feedstock comprising C₁₄-C₂₄ fatty acids, fatty acid esters, and/or fatty acid glycerides to yield a heavy hydrotreater fraction comprising C₁₄-C₂₄ n-paraffins; hydroisomerizing and hydrocracking the heavy hydrotreater fraction with a hydroisomerization catalyst under conditions yielding a hydroisomerizer product comprising a heavy hydroisomerizer fraction and a light paraffinic kerosene (LPK) where the LPK includes C₈-C₁₁ hydrocarbons and a ratio of isoparaffins to n-paraffins of about 2:1 or greater; and separating a sustainable aviation fuel (SAF) from the hydroisomerizer product; where the SAF comprises at least a portion of the LPK; the LPK has an existent gum value of 7 mg/100 mL or less as measured according to IP 540 air evaporation method and further includes (a) a weight ratio of isoparaffins to n-paraffins of about 2:1 or greater, or (b) no detectable hydrocarbons with 14 or more carbon atoms as measured by gas chromatography, or (c) a weight ratio of isoparaffins to n-paraffins of about 2:1 or greater and no detectable hydrocarbons with 14 or more carbon atoms as measured by gas chromatography; and the SAF has an existent gum value of 7 mg/100 mL or less as measured according to IP 540 air evaporation method. In a related aspect, the present technology provides a biorenewable SAF produced according to any embodiment of the method of the present technology for producing biorenewable SAF.

The biorenewable feedstock of any aspect and any embodiment disclosed herein includes free fatty acids, fatty acid esters (including mono-, di-, and trigylcerides), or combinations of any two or more thereof. For example, the free fatty acids may include free fatty acids obtained by stripping free fatty acids from a triglyceride transesterification feedstock. The biorenewable feedstock may include animal fats, animal oils, plant fats, plant oils, vegetable fats, vegetable oils, greases, or mixtures of any two or more thereof. The fatty acid esters may include fatty acid methyl ester, a fatty acid ethyl ester, a fatty acid propyl ester, a fatty acid butyl ester, or mixtures of any two or more thereof. The biorenewable feedstock may include the fatty acid distillate from vegetable oil deodorization. Depending on level of pretreatment, fats, oils, and greases, may contain between about 1 wppm and about 1,000 wppm phosphorus, and between about 1 wppm and about 500 wppm total metals (mainly sodium, potassium, magnesium, calcium, iron, and copper). Plant and/or vegetable oils and/or microbial oils include, but are not limited to, corn oil, distiller's corn oil, inedible corn oil, babassu oil, carinata oil, soybean oil, canola oil, coconut oil, rapeseed oil, tall oil, tall oil fatty acid, palm oil, palm oil fatty acid distillate, palm sludge oil, jatropha oil, palm kernel oil, sunflower oil, castor oil, camelina oil, archaeal oil, bacterial oil, fungal oil, protozoal oil, algal oil, seaweed oil, oils from halophiles, oils (e.g., seed oils) from field pennycress, oils (e.g., seed oils) from other flowering plants, and mixtures of any two or more thereof. These may be classified as crude, degummed, and RBD (refined, bleached, and deodorized) grade, depending on level of pretreatment and residual phosphorus and metals content. However, any of these grades may be used in the present technology. Animal fats and/or oils as used above includes, but is not limited to, inedible tallow, edible tallow, technical tallow, floatation tallow, bleachable fancy tallow, lard, technical lard, choice white grease, poultry fat, poultry oils, fish fat, fish oils, and mixtures of any two or more thereof. Greases may include, but are not limited to, yellow grease, brown grease, waste vegetable oils, restaurant greases, trap grease from municipalities such as water treatment facilities, spent oils from industrial packaged food operations, and mixtures of any two or more thereof. The biorenewable feedstock may include animal fats, poultry oil, soybean oil, canola oil, carinata oil, rapeseed oil, palm oil, jatropha oil, castor oil, camelina oil, seaweed oil, halophile oils, rendered fats, restaurant greases, brown grease, yellow grease, waste industrial frying oils, fish oils, tall oil, tall oil fatty acids, or mixtures of any two or more thereof. The biorenewable feedstock may include animal fats, restaurant greases, brown grease, yellow grease, waste industrial frying oils, or mixtures of any two or more thereof. In any embodiment herein, the biorenewable feedstock may include branched C₈, C₁₂, and/or C₁₆ olefins (e.g., formed by oligomerization of bio-isobutylene), branched C₁₅ olefins (e.g., produced via fermentation of sugars).

As noted in the previous paragraph, the biorenewable feedstock may be pretreated. For example, in any aspect and embodiment, the biorenewable feedstock may optionally be pretreated to remove phosphorus and metal contaminants to less than 10 wppm total, such as described in U.S. Pat. No. 9,404,064. Such pretreatments include, but are not limited to, degumming, neutralization, bleaching, deodorizing, or a combination of any two or more thereof. One type of degumming is acid degumming, which involves contacting the fat/oil with concentrated aqueous acids. Exemplary acids are phosphoric, citric, and maleic acids. This pretreatment step removes metals such as calcium and magnesium in addition to phosphorus. Neutralization is typically performed by adding a caustic (referring to any base, such as aqueous NaOH) to the acid-degummed fat/oil. The process equipment used for acid degumming and/or neutralization may include high shear mixers and disk stack centrifuges. Bleaching typically involves contacting the degummed fat/oil with adsorbent clay and filtering the spent clay through a pressure leaf filter. Use of synthetic silica instead of clay is reported to provide improved adsorption. The bleaching step removes chlorophyll and much of the residual metals and phosphorus. Any soaps that may have been formed during the caustic neutralization step (i.e., by reaction with free fatty acids) are also removed during the bleaching step. The aforementioned treatment processes are known in the art and described in the patent literature, including but not limited to U.S. Pat. Nos. 4,049,686, 4,698,185, 4,734,226, and 5,239,096.

Bleaching as used herein is a filtration process common to the processing of glyceride oils. Many types of processing configurations and filtration media such as diatomaceous earth, perlite, silica hydrogels, cellulosic media, clays, bleaching earths, carbons, bauxite, silica aluminates, natural fibers and flakes, synthetic fibers and mixtures thereof are known to those skilled in the art. Bleaching can also be referred to by other names such as clay treating which is a common industrial process for petroleum, synthetic and biological feeds and products.

Additional types of filtration may be performed to remove suspended solids from the biorenewable feedstock before and/or after and/or in lieu of degumming and/or bleaching. In some embodiments, rotoscreen filtration is used to remove solids larger than about 1 mm from the biorenewable feedstock. Rotoscreen filtration is a mechanically vibrating wire mesh screen with openings of about 1 mm or larger that continuously removes bulk solids. Other wire mesh filters of about 1 mm or larger housed in different types of filter may be also be employed, including self-cleaning and backwash filters, so long as they provide for bulk separation of solids larger than 1 mm, such as from about 1 mm to about 20 mm. In embodiments where bleaching through clay-coated pressure leaf filter is not used, cartridge or bag filters with micron ratings from about 0.1 to about 100 may be employed to ensure that only the solubilized and or finely suspended (e.g., colloidal phase) adulterants are present in the feed stream. Filtration is typically performed at temperatures high enough to ensure the feed stream is a liquid of about 0.1 to 100 cP viscosity. This generally translates into a temperature range of 20° C. to 90° C. (about 70° F. to about 195° F.).

In any embodiment disclosed herein, the free fatty acids of the mixture may include fatty acids produced from hydrolysis of fatty acid esters of fat, oil, and/or grease. In any embodiment disclosed herein, the free fatty acids may include fatty acids from tall oil and/or produced from the hydrolysis of tall oil esters. In any embodiment disclosed herein, the free fatty acids may include fatty acids from palm fatty acid distillate. In any embodiment disclosed herein, the free fatty acids may include fatty acids distilled from fats, oils, and/or greases such as those containing at least about 10 wt % free fatty acids. In any embodiment disclosed herein, the free fatty acids may include fatty acids distilled from palm sludge oil and/or used cooking oil. In any embodiment disclosed herein, the free fatty acids may include oleic acid, linoleic acid, stearic acid, palmitic acid, or a combination of any two or more thereof. In any embodiment disclosed herein, the free fatty acids may include a soap form (e.g., a sodium soap and/or a potassium soaps) of the free fatty acid where, in such embodiments including a soap form, the free fatty acids have an alkalinity of at least 200 mg/kg, at least 500 mg/kg, or at least 1000 mg/kg.

In any embodiment disclosed herein, the biorenewable feedstock may include about 5 wt. % to about 90 wt. % free fatty acids (FFAs). Thus, in any aspect and embodiment disclosed herein, the biorenewable feedstock may include free fatty acids in an amount of about 5 wt. %, about 10 wt. %, about 15 wt. %, about 20 wt. %, about 25 wt. %, about 30 wt. %, about 35 wt. %, about 40 wt. %, about 45 wt. %, about 50 wt. %, about 55 wt. %, about 60 wt. %, about 65 wt. %, about 70 wt. %, about 75 wt. %, about 80%, about 85%, about 90%, or any range including and/or in between any two of these values.

Suitable hydrotreatment catalysts for hydrotreating the biorenewable feedstock of any aspect or embodiment of the present technology include Co, Mo, Ni, Pt, Pd, Ru, W, NiMo, NiW, CoMo, or combinations of any two or more thereof. The hydrotreatment catalyst may include NiMo, NiW, CoMo, and combinations of any two or more thereof. Supports for the hydrotreatment catalyst include alumina and alumina with silicon oxides and/or phosphorus oxides. It should be noted that one of ordinary skill in the art can select an appropriate hydrotreatment catalyst to provide a particular result and still be in accordance with the present technology.

In any aspect or embodiment of the present technology, hydrotreating the biorenewable feedstock may include contacting a feed stream (the feed stream including the biorenewable feedstock) with a hydrotreatment catalyst in a fixed bed hydrotreatment reactor to produce a heavy hydrotreater fraction. In any aspect or embodiment herein, it may be that the feed stream further includes a petroleum-based feedstock or does not include a petroleum-based feedstock. The fixed bed hydrotreatment reactor may be at a temperature less than about 750° F. (400° C.), and may be at a pressure from about 200 psig (13.8 barg) to about 4,000 psig (275 barg). The fixed bed hydrotreatment reactor may be a continuous fixed bed hydrotreatment reactor. In any aspect or embodiment, the feed stream further include a diluent. The diluent may include a recycled hydroprocessed product (e.g., at least a portion of the heavy hydrotreater fraction), a distilled fraction of the heavy hydrotreater fraction, a petroleum-based hydrocarbon fluid, a synthetic hydrocarbon product stream from a Fischer-Tropsch process, a hydrocarbon product stream produced by fermentation of sugars (e.g. farnesene), natural hydrocarbons such as limonene and terpene, natural gas liquids, or mixtures of any two or more thereof. The volume ratio of diluent to biorenewable feedstock may be about 0.5:1 to about 20:1; thus, the volume ratio of diluent to biorenewable feedstock may be about 1:1, about 2:1, about 3:1, about 4:1, about 5:1, about 6:1, about 7:1, about 8:1, about 9:1, about 10:1, about 11:1, about 12:1, about 13:1, about 14:1, about 15:1, about 16:1, about 17:1, about 18:1, about 19:1, about 20:1, or any range including and/or in between any two of these values.

In any aspect or embodiment of the present technology including a fixed bed reactor in hydrotreating the biorenewable feedstock, the fixed bed reactor may be at a temperature falling in the range from about 480° F. (250° C.) to about 750° F. (400° C.). The fixed bed reactor may operate at a temperature of about 450° F. (230° C.), about 500° F. (260° C.), about 540° F. (280° C.), about 570° F. (300° C.), about 610° F. (320° C.), about 645° F. (340° C.), about 680° F. (360° C.), about 720° F. (380° C.), about 750° F. (400° C.), or any range including and/or in between any two of these values. A weighted average bed temperature (WABT) is commonly used in fixed bed, adiabatic reactors to express the “average” temperature of the reactor which accounts for the nonlinear temperature profile between the inlet and outlet of the reactor.

$$\begin{matrix}WABT = {\sum }_{i = 1}^{N} ( {WABT}_{i} ) ( {Wc}_{i} ) \\ {WABT}_{i} = \frac{{T}_{i}^{in} + 2 {T}_{i}^{out}}{3}\end{matrix}$$

In the equation above, Tᵢⁱⁿ and Tᵢ^{out} refer to the temperature at the inlet and outlet, respectively, of catalyst bed i. As shown, the WABT of a reactor system with N different catalyst beds may be calculated using the WABT of each bed (WABTᵢ) and the weight of catalyst in each bed (Wcᵢ).

To maintain the active metal sulfide functionality of the hydrotreatment catalyst despite the negligible presence of organic sulfur in most biorenewable feedstocks, in any aspect or embodiment of the present technology the biorenewable feedstock and/or feed stream may be supplemented with a sulfur compound that decomposes to hydrogen sulfide when heated and/or contacted with a catalyst. The sulfur compound may include methyl mercaptan, ethyl mercaptan, n-butyl mercaptan, dimethyl sulfide (DMS), dimethyl disulfide (DMDS), dimethylsulfoxide (DMSO), diethyl sulfide, di-tert-butyl polysulfide (TBPS), di-octyl polysulfide, di-tert-nonyl polysulfude (TNPS), carbon disulfide, thiophene, or mixtures of any two or more thereof. The concentration of the sulfur compound (e.g., in the feed stream) may be from about 50 ppm to about 2,000 ppm by weight sulfur. In any aspect or embodiment of the present technology, hydrotreating the biorenewable feedstock may include hydrotreating the biorenewable feedstock together with a petroleum-based feedstock—for example, the feed stream may include a petroleum-based feedstock in addition to the biorenewable feedstock—where the petroleum-based feedstock provides the sulfur, either in combination with or in the absence of the above mentioned sulfur compounds.

In any aspect or embodiment of the present technology, hydrotreating the biorenewable feedstock may include a pressure from about 200 psig (about 13.8 barg) to about 4,000 psig (about 275 barg) (e.g., hydrotreating in a fixed bed hydrotreatment reactor at a pressure from about 200 psig (about 13.8 barg) to about 4,000 psig (about 275 barg)). The pressure may be about 300 psig (21 barg), about 400 psig (28 barg), about 500 psig (34 barg), about 600 psig (41 barg), about 700 psig (48 barg), about 800 psig (55 barg), about 900 psig (62 barg), about 1,000 psig (69 barg), about 1,100 psig (76 barg), about 1,200 psig (83 barg), about 1,300 psig (90 barg), about 1,400 psig (97 barg), about 1,500 psig (103 barg), about 1,600 psig (110 barg), about 1,700 psig (117 barg), about 1,800 psig (124 barg), about 1,900 psig (131 barg), about 2,000 psig (138 barg), about 2,200 psig (152 barg), about 2,400 psig (165 barg), about 2,600 psig (179 barg), about 2,800 psig (193 barg), about 3,000 psig (207 barg), about 3,200 psig (221 barg), about 3,400 psig (234 barg), about 3,600 psig (248 barg), about 3,800 psig (262 barg), about 3,900 psig (269 barg), or any range including and/or in between any two of these values. For example, the pressure may be from about 1,000 psig (69 barg) to about 2,000 psig (138 barg).

In any aspect or embodiment of the present technology including a fixed bed reactor in hydrotreating the biorenewable feedstock, the liquid hourly space velocity (LHSV) of the biorenewable feedstock through the fixed bed hydrotreatment reactor may be from about 0.2 h⁻¹ to about 10.0 h⁻¹; thus, the LHSV may be about 0.3 h⁻¹, about 0.4 h⁻¹, about 0.5 h⁻¹, about 0.6 h⁻¹, about 0.7 h⁻¹, about 0.8 h⁻¹, about 0.9 h⁻¹, about 1.0 h⁻¹, about 1.2 h⁻¹, about 1.4 h⁻¹, about 1.6 h⁻¹, about 1.8 h⁻¹, about 2.0 h⁻¹, about 2.2 h⁻¹, about 2.4 h⁻¹, about 2.6 h⁻¹, about 2.8 h⁻¹, about 3.0 h⁻¹, about 3.2 h⁻¹, about 3.4 h⁻¹, about 3.6 h⁻¹, about 3.8 h⁻¹, about 4.0 h⁻¹, about 4.2 h⁻¹, about 4.4 h⁻¹, about 4.6 h⁻¹, about 4.8 h⁻¹, about 5.0 h⁻¹, about 5.2 h⁻¹, about 5.4 h⁻¹, about 5.6 h⁻¹, about 5.8 h⁻¹, about 6.0 h⁻¹, about 6.2 h⁻¹, about 6.4 h⁻¹, about 6.6 h⁻¹, about 6.8 h⁻¹, about 7.0 h⁻¹, about 7.2 h⁻¹, about 7.4 h⁻¹, about 7.6 h⁻¹, about 7.8 h⁻¹, about 8.0 h⁻¹, about 8.2 h⁻¹, about 8.4 h⁻¹, about 8.6 h⁻¹, about 8.8 h⁻¹, about 9.0 h⁻¹, about 9.2 h⁻¹, about 9.4 h⁻¹, about 9.6 h⁻¹, about 9.8 h⁻¹, or any range including and/or between any two of these values.

In any aspect or embodiment of the present technology, hydrotreating the biorenewable feedstock may including combining the biorenewable feedstock (and/or feed stream including the biorenewable feedstock) with a hydrogen-rich treat gas. The ratio of hydrogen-rich treat gas to biorenewable feedstock may be in the range of about 2,000 to about 10,000 SCF/bbl (in units of normal liter of gas per liter of liquid (Nl/l), about 355 Nl/1 to about 1780 Nl/l). The ratio of hydrogen-rich treat gas to biorenewable feedstock may be about 2,500 SCF/bbl (about 445 Nl/l), about 3,000 SCF/bbl (about 535 Nl/l), about 3,500 SCF/bbl (about 625 Nl/l), about 4,000 SCF/bbl (about 710 Nl/l), about 4,500 SCF/bbl (about 800 Nl/l), about 5,000 SCF/bbl (about 890 Nl/l), about 5,500 SCF/bbl (about 980 Nl/l), about 6,000 SCF/bbl (about 1070 Nl/l), about 6,500 SCF/bbl (about 1160 Nl/l), about 7,000 SCF/bbl (about 1250 Nl/l), about 7,500 SCF/bbl (about 1335 Nl/l), about 8,000 SCF/bbl (about 1425 Nl/l), about 8,500 SCF/bbl (about 1515 Nl/l), about 9,000 SCF/bbl (about 1600 Nl/l), about 9,500 SCF/bbl (about 1690 Nl/l), or any range including and/or in between any two of these values. The hydrogen-rich treat gas may contain from about 70 mol % to about 100 mol % hydrogen. In terms of mass ratio, the ratio of the feed stream to hydrogen-rich treat gas is from about 5:1 to 25:1. The ratio of the feed stream to hydrogen-rich treat gas may be about 6:1, about 7:1, about 8:1, about 9:1, about 10:1, about 11:1, about 12:1, about 13:1, about 14:1, about 15:1, about 16:1, about 17:1, about 18:1, about 19:1, about 20:1, about 22:1, about 23:1, about 24:1), or any range including and/or in between any two of these values.

As discussed above, each aspect of the method includes hydroisomerizing and hydrocracking the heavy hydrotreater fraction with a hydroisomerization catalyst under conditions yielding a hydroisomerizer product. The conditions ensure the hydroisomerizer product includes a heavy hydroisomerizer fraction and the LPK, where (in any aspect or embodiment) the conditions may ensure the LPK includes a ratio of isoparaffins to n-paraffins of about 2:1 or greater. In any aspect or embodiment disclosed herein, the hydroisomerization catalyst may be a bifunctional catalysts having a hydrogenation-dehydrogenation activity from a Group VIB and/or Group VIII metal and acidic activity from an amorphous or crystalline support such as amorphous silica-alumina (ASA), silicon-aluminum-phosphate (SAPO) molecular sieve, or aluminum silicate zeolite (ZSM). In any aspect or embodiment disclosed herein, the hydroisomerization catalyst may include platinum, palladium, or a combination thereof on crystalline silica-alumina supports having zeolites. In any aspect or embodiment disclosed herein, the hydroisomerization catalyst may include tungsten (especially useful for when sulfur species are present in the heavy hydrotreater fraction, e.g., “sour service”). In any aspect or embodiment disclosed herein, the hydroisomerization catalyst may include Pt/Pd-on-ASA and/or Pt-on-SAPO-11. In any aspect or embodiment, the conditions may include a temperature of about 200° C. to about 500° C.; thus, the hydroisomerizing and hydrocracking may be conducted at a temperature of about 220° C., about 240° C., about 260° C., about 280° C., about 300° C., about 304° C., about 320° C., about 330° C., about 335° C., about 340° C., about 350° C., about 360° C., about 370° C., about 380° C., about 390° C., about 400° C., about 420° C., about 440° C., about 460° C., about 480° C., or ranges including and/or in between any two of these values or above any one of these values. Particularly useful in ensuring the LPK includes a ratio of isoparaffins to n-paraffins of about 2:1 or greater are temperatures of about 580° F. (about 304° C.) to about 750° F. (about 400° C.). In any aspect or embodiment, the conditions may include a pressure of about 250 psig to about 3,000 psig; thus, the pressure may be about 250 psig, about 300 psig, about 400 psig, about 500 psig, about 600 psig, about 700 psig, about 800 psig, about 900 psig, about 1,000 psig, about 1,100 psig, about 1,200 psig, about 1,300 psig, 1,400 psig, about 1,500 psig, about 1,600 psig, about 1,700 psig, about 1,800 psig, about 1,900 psig, about 2,000 psig, 2,100 psig, about 2,200 psig, about 2,300 psig, 2,400 psig, about 2,500 psig, about 2,600 psig, about 2,700 psig, about 2,800 psig, about 2,900 psig, about 3,000 psig, or any range including and/or in between any two of these values.

In any aspect or embodiment of the present technology, hydroisomerizing and hydrocracking the heavy hydrotreater fraction may including combining the heavy hydrotreater fraction (and/or a feed stream including the heavy hydrotreater fraction) with a hydrogen-rich treat gas. The ratio of hydrogen-rich treat gas to heavy hydrotreater fraction may be in the range of about 1,000 to about 5,000 SCF/bbl; thus, the ratio of hydrogen-rich treat gas to heavy hydrotreater fraction may be about 1,000 SCF/bbl, about 1,500 SCF/bbl, about 2,000 SCF/bbl, about 2,500 SCF/bbl, about 3,000 SCF/bbl, about 3,500 SCF/bbl, about 4,000 SCF/bbl, about 4,500 SCF/bbl, about 5,000 SCF/bbl, or any range including and/or in between any two of these values. The hydrogen-rich treat gas may contain from about 70 mol % to about 100 mol % hydrogen.

In any aspect or embodiment, hydroisomerizing and hydrocracking may be conducted in a continuous fixed-bed reactor (e.g., both hydroisomerizing and hydrocracking occur in a single fixed-bed reactor). When conducted in a continuous fixed-bed reactor, the liquid hourly space velocity (LHSV) of heavy hydrotreater fraction through the continuous fixed-bed reactor may be about 0.1 h⁻¹ to about 4.0 h⁻¹; thus, the LHSV may be about 0.1 h⁻¹, about 0.2 h⁻¹, about 0.3 h⁻¹, about 0.4 h⁻¹, about 0.5 h⁻¹, about 0.6 h⁻¹, about 0.7 h⁻¹, about 0.8 h⁻¹, about 0.9 h⁻¹, about 1.0 h⁻¹, about 1.2 h⁻¹, about 1.4 h⁻¹, about 1.6 h⁻¹, about 1.8 h⁻¹, about 2.0 h⁻¹, about 2.2 h⁻¹, about 2.4 h⁻¹, about 2.6 h⁻¹, about 2.8 h⁻¹, about 3.0 h⁻¹, about 3.2 h⁻¹, about 3.4 h⁻¹, about 3.6 h⁻¹, about 3.8 h⁻¹, about 4.0 h⁻¹, or any range including and/or between any two of these values.

In any aspect or embodiment, separating the LPK from the hydroisomerizer product and/or separating the SAF from the hydroisomerizer product may include fractionation. The fractionation of any aspect or embodiment may be conducted in a distillation column equipped with a reboiler or stripping steam in the bottom of the column, and a condenser at the top. In such embodiments, the reboiler or stripping steam provide the thermal energy to vaporize the heavier fraction of the hydrocarbons while the condenser cools the lighter hydrocarbon vapors to return hydrocarbon liquid back into the top of the column. The distillation column is equipped with a plurality of features (e.g., plates, protrusions, and/or beds of packing material) wherein the rising vapor and falling liquid come into counter-current contact. The column's temperature profile from bottom to top is dictated by the composition of the hydrocarbon feed and the column pressure. In some embodiments, column pressures range from about 200 psig (about 13.8 barg) to about −14.5 psig (about −1 barg). The column is equipped with one or a plurality of feed nozzles. A portion of the condenser liquid (typically 10 to 90 vol %) is drawn off as overhead distillate product while the rest is allowed to reflux back to the column. While some embodiments employ a plurality of draw-off nozzles to fractionate the feed into multiple cuts in the same column, other embodiments achieve the same separation using a plurality of columns in series, each separating the feed into an overhead fraction and a bottom fraction. In any aspect or embodiment, the separating may be performed so that the LPK includes no detectable hydrocarbons with 14 carbon atoms or more as measured by gas chromatography.

In any aspect or embodiment where the LPK includes no detectable hydrocarbons with 14 carbon atoms or more as measured by gas chromatography, the LPK may have a weight ratio of isoparaffins to n-paraffins of about 1:1 to about 5:1 (or greater); thus, the LPK of any aspect or embodiment of the present technology (when the LPK includes no detectable hydrocarbons with 14 carbon atoms or more as measured by gas chromatography) may have a weight ratio of isoparaffins to n-paraffins of about 1:1, about 1.1:1, about 1.2:1, about 1.3:1, about 1.4:1, about 1.5:1, about 1.6:1, about 1.7:1, about 1.8:1, about 1.9:1, about 2.0:1, about 2.1:1, about 2.2:1, about 2.3:1, about 2.4:1, about 2.5:1, about 2.6:1, about 2.7:1, about 2.8:1, about 2.9:1, about 3.0:1, about 3.2:1, about 3.4:1, about 3.6:1, about 3.8:1, about 4.0:1, about 4.2:1, about 4.4:1, about 4.6:1, about 4.8:1, about 5.0:1, or any range including and/or in between any two of these values.

In any aspect or embodiment where the LPK includes detectable hydrocarbons with 14 carbon atoms or more as measured by gas chromatography, the LPK may have a weight ratio of isoparaffins to n-paraffins of about 2:1 to about 5:1 (or greater), such as about 2.0:1, about 2.1:1, about 2.2:1, about 2.3:1, about 2.4:1, about 2.5:1, about 2.6:1, about 2.7:1, about 2.8:1, about 2.9:1, about 3.0:1, about 3.2:1, about 3.4:1, about 3.6:1, about 3.8:1, about 4.0:1, about 4.2:1, about 4.4:1, about 4.6:1, about 4.8:1, about 5.0:1, or any range including and/or in between any two of these values. As discussed previously, such weight ratios of isoparaffins to n-paraffins are provided by the conditions of the hydroisomerizing and hydrocracking of the heavy hydrotreater fraction.

In any aspect or embodiment of the present technology, the LPK may have a flash point of about 38° C. or higher, such as about 38° C. to about 42° C.; thus, the flash point of the LPK may be about 38° C. (about 100° F.), about 39° C. (about 102° F.), about 40° C. (about 104° F.), about 41° C. (about 106° F.), about 42° C. (about 108° F.), or any range including and/or in between any two of these values. In any aspect or embodiment of the present technology, the LPK may have a cetane number (i.e., a Derived Cetane Number; “DCN”) of about 55 or greater, such as about 55, about 60, about 65, about 70, about 75, about 80, or any range including and/or in between any two of these values. In any aspect or embodiment of the present technology, the LPK may have a freeze point (as determined according to ASTM D5972) less than about −40° C.; thus the LPK may include a freeze point as determined according to ASTM D5972 of about −40° C., about −42° C., about −44° C., about −46° C., about −48° C., about −50° C., about −52° C., about −54° C., about −56° C., about −58° C., about −60° C., about −62° C., about −64° C., about −66° C., about −68° C., about −70° C., or any range including and/or in between any two of these values or less than any one of these values. In any aspect or embodiment of the present technology, the LPK may exhibit at least 80 vol. % boiling in the 150-180° C. range based on ASTM D86 test method.

In any aspect or embodiment of the present technology, the LPK may include about 99.7 wt. % or greater of hydrocarbons with less than 14 carbon atoms. In any aspect or embodiment of the present technology, the LPK may include about 99.8 wt. % or greater of hydrocarbons with less than 14 carbon atoms. In any aspect or embodiment of the present technology, the LPK may include about 99.9 wt. % or greater of hydrocarbons with less than 14 carbon atoms. The LPK may have, any aspect or embodiment of the present technology, less than about 0.1 wt % oxygenates, and may have oxygenates in the amount of about 0.09 wt %, about 0.08 wt %, about 0.07 wt %, about 0.05 wt %, about 0.04 wt %, about 0.03 wt %, about 0.02 wt %, about 0.01 wt %, or any range including and/or in between any two of these values or below any one of these values. Such low values of oxygenates can be detected through appropriate analytical techniques, including but not limited to Instrumental Neutron Activation Analysis.

The LPK of any aspect or embodiment of the present technology may have less than about 0.1 wt % of aromatics. Thus, LPK may contain aromatics in the amount of about 0.09 wt %, about 0.08 wt %, about 0.07 wt %, about 0.06 wt %, about 0.05 wt %, about 0.04 wt %, about 0.03 wt %, about 0.02 wt %, about 0.01 wt %, about 0.009 wt %, about 0.008 wt %, about 0.007 wt %, about 0.006 wt %, about 0.005 wt %, about 0.004 wt %, about 0.003 wt %, about 0.002 wt %, about 0.001 wt %, or any range including and/or in between any two of these values or below any one of these values. In any aspect or embodiment of the present technology, it may be that the LPK includes no detectable aromatics as measured by gas chromatography. The LPK may contain less than about 0.01 wt % benzene, and may contain benzene in the amount of about 0.008 wt %, about 0.006 wt %, about 0.004 wt %, about 0.002 wt %, about 0.001 wt %, about 0.0008 wt %, about 0.0006 wt %, about 0.0004 wt %, about 0.0002 wt %, about 0.0001 wt %, about 0.00008 wt %, about 0.00006 wt %, about 0.00004 wt %, about 0.00002 wt %, about 0.00001 wt %, or any range including and/or in between any two of these values or below any one of these values. Such low values of benzene may be determined through appropriate analytical techniques, including but not limited to two dimensional gas chromatography of the LPK. In any aspect or embodiment of the present technology, it may be that the LPK includes no detectable benzene.

The LPK of any aspect or embodiment of the present technology may have a sulfur content less than about 5 wppm. Thus, in any aspect or embodiment of the present technology, the LPK may have a sulfur content of about 4 wppm, about 3 wppm, about 2 wppm, about 1 wppm, about 0.9 wppm, about 0.8 wppm, about 0.7 wppm, about 0.6 wppm, about 0.5 wppm, about 0.4 wppm, about 0.3 wppm, about 0.2 wppm, about 0.1 wppm, or any range including and/or in between any two of these values or below any one of these values.

In any aspect or embodiment of the present technology, the SAF may include the LPK of any aspect or embodiment disclosed herein in an amount of about 30 wt. % or higher. Thus, in any aspect or embodiment of the present technology the SAF may include the LPK in an amount of about 30 wt. %, about 40 wt. %, about 50 wt. %, about 60 wt. %, about 70 wt. %, about 80 wt. %, about 90 wt. %, about 95 wt. %, or any range including and/or in between any two of these values or greater than any one of these values. In any aspect or embodiment of the present technology, the SAF may further include C₁₂-C₁₆ isoparaffins such as C₁₂-C₁₆ isoparaffins from the heavy hydroisomerizer fraction and/or petroleum-based C₁₂-C₁₆ isoparaffins.

In any aspect or embodiment, separating the LPK from the hydroisomerizer product and/or separating the SAF from the hydroisomerizer product may include separating a renewable diesel from the hydroisomerizer product, the renewable diesel comprising at least a portion of the heavy hydroisomerizer fraction. The renewable diesel may have, In any aspect or embodiment, less than about 0.1 wt % oxygenates, and may have oxygenates in the amount of about 0.09 wt %, about 0.08 wt %, about 0.07 wt %, about 0.05 wt %, about 0.04 wt %, about 0.03 wt %, about 0.02 wt %, about 0.01 wt %, or any range including and/or in between any two of these values or below any one of these values. The renewable diesel of any aspect or embodiment may have less than about 0.1 wt % of aromatics. Thus, the renewable diesel may contain aromatics in the amount of about 0.09 wt %, about 0.08 wt %, about 0.07 wt %, about 0.06 wt %, about 0.05 wt %, about 0.04 wt %, about 0.03 wt %, about 0.02 wt %, about 0.01 wt %, about 0.009 wt %, about 0.008 wt %, about 0.007 wt %, about 0.006 wt %, about 0.005 wt %, about 0.004 wt %, about 0.003 wt %, about 0.002 wt %, about 0.001 wt %, or any range including and/or in between any two of these values or below any one of these values. In any aspect or embodiment, it may be that the renewable diesel includes no detectable aromatics as measured by gas chromatography. The renewable diesel may contain less than about 0.01 wt % benzene, and may contain benzene in the amount of about 0.008 wt %, about 0.006 wt %, about 0.004 wt %, about 0.002 wt %, about 0.001 wt %, about 0.0008 wt %, about 0.0006 wt %, about 0.0004 wt %, about 0.0002 wt %, about 0.0001 wt %, about 0.00008 wt %, about 0.00006 wt %, about 0.00004 wt %, about 0.00002 wt %, about 0.00001 wt %, or any range including and/or in between any two of these values or below any one of these values. The renewable diesel may have a sulfur content less than about 5 wppm; thus, the renewable diesel may have a sulfur content of about 4 wppm, about 3 wppm, about 2 wppm, about 1 wppm, about 0.9 wppm, about 0.8 wppm, about 0.7 wppm, about 0.6 wppm, about 0.5 wppm, about 0.4 wppm, about 0.3 wppm, about 0.2 wppm, about 0.1 wppm, or any range including and/or in between any two of these values or below any one of these values.

The renewable diesel in any aspect or embodiment of the present technology may have a cloud point of less than about 0° C. and may further have a cetane number of 60 or higher. Thus, in any embodiment herein, the renewable diesel may include a cloud point of about 0° C., about −2° C., about −4° C., about −6° C., about −8° C., about −10° C., about −12° C., about −14° C., about −16° C., about −18° C., about −20° C., about −22° C., about −24° C., about −26° C., about −28° C., about −30° C., about −32° C., about −34° C., about −36° C., about −38° C., about −40° C., about −42° C., about −44° C., about −46° C., about −48° C., about −50° C., about −52° C., about −54° C., about −56° C., about −58° C., about −60° C., or any range in between and/or including any two of these values or less than any one of these values.

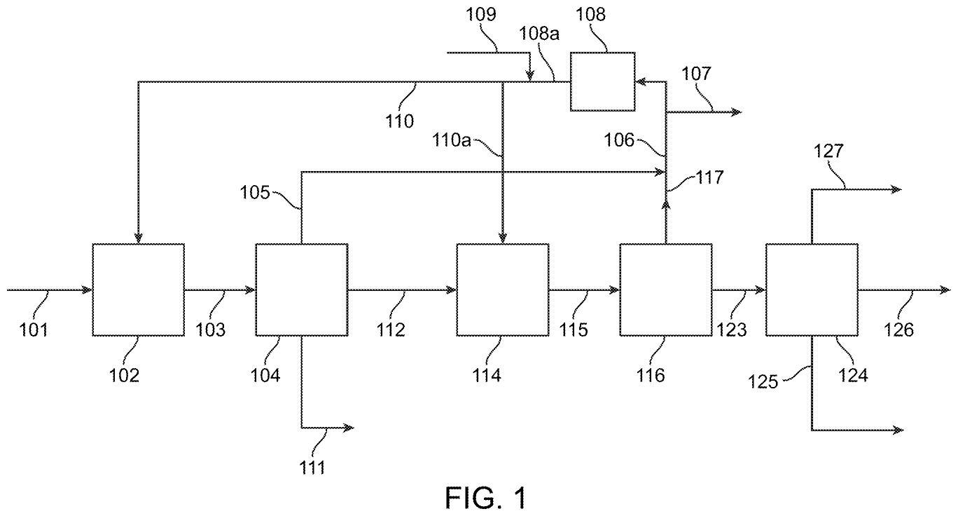

Referring now to the figures, FIG. 1 provides a non-limiting exemplary embodiment of the present technology. In FIG. 1, a renewable feed 101 having a naturally occurring fatty acid and fatty acid esters/glycerides is transferred to a hydrotreater 102 where it reacts with hydrogen under a pressure from about 300 psig to about 3,000 psig (e.g., from about 500 psig to about 2,000 psig). As discussed previously, hydrotreater 102 may include a packed bed of a sulfided catalyst such as nickel-molybdenum (NiMo), nickel-tungsten (NiW), or cobalt-molybdenum (CoMo) on a 7-alumina support.

Feed 101 may be preheated before entering hydrotreater 102, where hydrotreater 102 may operate from about 300° F. to about 900° F. (e.g., from about 550° F. to about 650° F.). In order to reduce the adiabatic temperature rise from the exothermic hydrotreating reactions and to maintain the hydrotreater 102 in the preferred operating temperature range, a number of methods known in the art may be used. These methods include, but are not limited to, feed dilution with a solvent or other diluent, liquid product or solvent recycle, and use of quench zones within the fixed-bed reactor wherein hydrogen is introduced.

The liquid hourly space velocity of feed 101 through hydrotreater 102 may be from about 0.2 h⁻¹ to about 10 h⁻¹ (e.g., from about 0.5 h⁻¹ to about 5.0 h⁻¹). The ratio of hydrogen-rich treat gas 110 to renewable feed 101 may be from about 2,000 to about 15,000 SCF/bbl (e.g., from about 4,000 to about 12,000 SCF/bbl). The hydrogen-rich treat gas 110 may contain from about 70 mol % to about 100 mol % hydrogen.

A hydrotreater effluent 103 includes a deoxygenated heavy hydrotreater fraction and a vapor fraction comprising unreacted hydrogen. The deoxygenated heavy hydrotreater fraction includes n-paraffins mainly in the C₁₃-C₂₄ range with up to 2% of compounds heavier than C₂₄. The hydrogen-rich vapors include C₁-C₃ hydrocarbons, water, carbon oxides, ammonia, and/or hydrogen sulfide, in addition to hydrogen. The heavy hydrotreater fraction in the liquid phase may be separated from the vapor phase components in a separation unit 104.

Separation unit 104 may use a high-pressure drum operated at hydrotreater discharge pressure (e.g., about 50 psig to about 3,000 psig; about 500 psig to about 2,000 psig), and the heavy hydrotreater fraction may be separated from hydrogen and gas phase hydrotreater byproducts such as water, carbon dioxide, ammonia, hydrogen sulfide, and/or propane. Depending on temperature, the water byproduct may be in vapor or liquid phase. The high-pressure drum may operates at a temperature of about 350° F. to about 500° F. whereby water, carbon oxides, ammonia, hydrogen sulfide, and/or propane are separated along with hydrogen in vapor phase from the heavy hydrocarbon fraction in liquid phase. Separation unit 104 may further include a high-pressure drum operating at a lower temperature (e.g., about 60° F. to about 250° F.) for condensing an aqueous stream 111. Aqueous stream 111 may include dissolved ammonia and/or carbon dioxide, is thus may be separated from the hydrogen-rich gas phase 105 that is subsequently recycled to the hydrotreater 102.

A heavy hydrotreater fraction 112 from the separation unit 104 may then be processed through a hydroisomerizer 114. The heavy hydrotreater fraction 112 may optionally be combined with a hydroisomerizer heavy fraction 125. Hydroisomerizer 114 may operate at a hydrogen pressure of about 250 psig to about 3,000 psig (e.g., about 1,000 psig to about 2,000 psig) where the hydrogen pressure may be provided by a hydrogen-rich gas 110a. Hydroisomerizer 114 temperatures may be about 400° F. to about 900° F. (e.g., about 580° F. to about 750° F.).

In hydroisomerizing and hydrocracking according to the present technology, hydrocracking converts at least a portion of the heavy hydrocarbon feed into lighter hydrocarbons such as liquefied petroleum gas (“LPG”) including C₃-C₄ hydrocarbons, a light naphtha (C₅-C₈ hydrocarbons), and LPK (including C₈-C₁₁ hydrocarbons). For a given hydroisomerization catalyst, hydrocracking increases with higher temperature and lower LHSV. Increased hydrocracking in turn results in an increase in the iso-paraffin to n-paraffin ration of the LPK. To produce the desired LPK that avoids existent gum non-compliance, while minimizing yield loss due to excessive cracking, the hydrocracking side-reactions need to result in the LPK having an iso/normal ratio of about 2.0 to about 5.0. When the iso/normal ratio is less than about 3.0, for example between about 1.0 and 2.8, the trace concentration of heavier hydrocarbons, specifically C₁₄ or heavier hydrocarbons, needs to be removed from the LPK in fractionation unit 124 (described later with respect to FIG. 1).

Effluent stream 115 exits hydroisomerizer 114. Effluent stream 115 is a two-phase fluid, from which hydrogen-rich gas 117 is separated from the hydroisomerizer product in a separation unit 116. Separation unit 116 may include a high pressure separation drum (not shown), operating at hydroisomerizer discharge pressure (e.g., about 500 psig to about 2,000 psig) in which hydrocarbon liquids are separated from hydrogen, hydrocarbon vapors, and/or any other gas phase products. Hydrogen-rich gas 117 from separation unit 116 is combined with a hydrogen-rich gas 105 from separation unit 104 and optionally processed through an absorption column and/or scrubber 108 to remove ammonia, carbon oxides, and/or hydrogen sulfide, before compression for recycle to hydrotreater 102 and/or hydroisomerizer 114. Depending on the contaminant to be removed, the scrubber 108 may use various solvents such as amine and caustic solutions. It will be understood to those of ordinary skill in the art that other gas cleanup technologies may be used instead of or in addition to scrubber 108 in order to remove contaminants that affect hydrotreater 102 and hydroisomerizer 114 catalyst activity and selectivity. Examples of alternative gas cleanup technologies include membrane systems and adsorbent beds.

A bleed gas 107 may be removed from recycle gas 106 to prevent buildup of gas phase contaminants that are not effectively removed in the scrubber 108. Cleaned hydrogen-rich gas 108a from scrubber 108 may be combined with makeup hydrogen 109 to form a hydrogen-rich gas stream 110 for hydrotreater 102 and hydroisomerizer 114.

Liquid hydrocarbon phase 123 from separation unit 116 is directed to fractionation unit 124 to fractionate the hydroisomerizer product into a wild naphtha stream 127, LPK fraction 126, and a heavy hydroisomerizer fraction 125. Heavy hydroisomerizer fraction 125 may optionally be recycled to hydroisomerizer 114. Fractionation unit 124 may be a single distillation column where LPK fraction 126 is recovered as a side draw, or two different distillation columns configured such that LPK fraction 126 is recovered as the overhead fraction of a second column after separation of the wild naphtha in a first column. In embodiments where the hydroisomerizer 114 is run to provide the LPK with an iso/normal ratio less than about 2.0, for example an iso/normal ratio between 1.0 and 1.8, then fractionation unit 124 should be configured and operated to ensure that no detectable hydrocarbons (by gas chromatography) with 14 or more carbon atoms are incorporated in the LPK. In the two column embodiment of fractionator unit 124, the LPK may be recovered as the overhead fraction in the second tower with provisions for achieving the specified separation of the C₁₄ and heavier hydrocarbons. Such provisions are known to persons of ordinary skill in the art and include increasing column reflux ratio and additional theoretical trays, as described more below.

Regardless of the configuration, the distillation columns may include a reboiler or a conduit for super-heated steam supply to provide the heat of vaporization and drive vapors up the column, and a condenser to supply cooling duty to condense the vapors and create reflux down the column. Each distillation column includes provisions for promoting contact between vapor and liquid. Trays or packing inside the column are used for this purpose and various types of these are well appreciated by a person of ordinary skill in the art. The required number of trays or height of packing is often expressed as the column's theoretical trays (or theoretical plates). In two column embodiments, the second distillation column wherein the LPK 126 (or a SAF stream comprising LPK) is separated as an overhead fraction, and the hydroisomerizer heavy fraction 125 as bottoms, may be a vacuum tower with about 10 to about 40 theoretical trays. In any embodiment, the vacuum tower may be operated at an absolute pressure of about 50 mm Hg to about 350 mm Hg to lower the temperature requirements for evaporation. In any embodiment, the hydroisomerizer heavy fraction 125 may be used as a renewable diesel fuel. In any embodiment, the wild naphtha stream 127 may be processed through a debutanizer tower (not shown) to split the stream into a C₃-C₄ LPG and a C₅-C₈ light naphtha. It will be understood by one of ordinary skill in the art that any configuration of distillation column and fractionation scheme or arrangement may be used so long as the system functions in accordance with the present technology. LPK 126 exiting fractionation unit 124 is a C₈-C₁₁ hydrocarbon fraction.

From the above description, it is clear that the present technology is well adapted to carry out the objects and to attain the advantages mentioned herein as well as those inherent in the invention. While presently preferred embodiments have been described for purposes of this disclosure, it will be understood that numerous changes may be made which will readily be understood to those of ordinary skill in the art and which are accomplished within the spirit of the technology disclosed and claimed. The present technology, thus generally described, will be understood more readily by reference to the following examples, which are provided by way of illustration and are not intended to be limiting of the present technology.

### Examples

### Example 1

A FOG feedstock comprising commercially sourced used cooking oil was subjected to hydrotreating in an adiabatic fixed-bed reactor operating at a temperature range of 540-680° F. across the reactor system, and under a hydrogen partial pressure of about 1700 psia. The hydrotreater was loaded with a catalyst system comprising NiMo sulfide catalyst. The hydrotreater effluent (a two-phase stream comprising hydrogen and water in the vapor phase) was processed through a hot separator to separate the gas/vapor from the liquid product stream. The latter was stripped with nitrogen at a pressure lower than the hot separator pressure. The stripping step was performed to remove the gas phase byproducts of hydrotreating (i.e. solubilized water, CO, CO₂, H₂S, and NH₃). The stripped liquid was sampled and found to be a hydrocarbon liquid comprising mainly C₁₄-Cis n-paraffins, with sulfur and nitrogen less than 1 ppm and an acid number below the detection limit of 0.02 mg KOH/g. This hydrocarbon liquid was subsequently subjected to hydroisomerization (HI) in a different fixed-bed reactor operating at a catalyst average temperature in the 600-620° F. range, under about 900 psia H₂ partial pressure. The HI reactor was loaded with a bifunctional catalyst comprising platinum. The HI reactor effluent was fractionated into three cuts: (1) diesel, (2) broad boiling range naphtha, and (3) LPG and non-condensables. The broad boiling range naphtha was analyzed via GC and was found to be a C₅-C₁₄+ isoparaffinic hydrocarbon composition, where Table 1 provide the results of the GC analysis.

TABLE 1
Hydrocarbon composition of the broad boiling range naphtha

| Carbon | Iso- | Normal | | Iso/normal |
|---|---|---|---|---|
| Number | paraffins | paraffins | Total | ratio |
| C5 | 7.37 | 10.05 | 17.42 | 0.73 |
| C6 | 3.67 | 12.79 | 16.46 | 0.29 |
| C7 | 5.78 | 11.27 | 17.05 | 0.51 |
| C8 | 8.37 | 10.65 | 19.02 | 0.79 |
| C9 | 6.66 | 7.15 | 13.81 | 0.93 |
| C10 | 6.01 | 4.24 | 10.25 | 1.42 |
| C11 | 2.63 | 1.93 | 4.56 | 1.36 |
| C12 | 0.89 | 0.22 | 1.11 | 4.05 |
| C13 | 0.01 | 0.01 | 0.02 | 1.00 |
| C14+ | 0.26 | 0.04 | 0.30 | 6.50 |

The broad boiling range naphtha was then stripped of light hydrocarbons to yield a light paraffinic kerosene (LPK) having a flash point in the 38-42° C. range. This was done by distilling light naphtha hydrocarbons (the C₈ and lighter components) as an overhead fraction and recovering the LPK as a bottoms fraction comprising mainly (about 98 wt. % or more) of C₈-C₁₁ hydrocarbons having with an iso/normal ratio of about 1. Multiple samples were taken for measurement of fuel properties with the results summarized in Table 2.

TABLE 2
Volatility Properties of LPK Compared to HEFA Fuel Specification

| | Test | | | | | | | |
|---|---|---|---|---|---|---|---|---|
| Property | Method | Specification | | Sample 1 | Sample 2 | Sample 3 | Sample 4 | Sample 5 |
| Distillation temperature, ° C. | | | | | | | | |
| 10% recovered (T10) | D86 | 205 | max | 153.2 | 152.9 | 155.3 | 155.6 | 155.0 |
| 50% recovered (T50) | D86 | | | 159.6 | 160.1 | 160.2 | 160.4 | 161.1 |
| 90% recovered (T90) | D86 | | | 175.1 | 178.0 | 174.5 | 174.1 | 177.1 |
| Final boiling point | D86 | 300 | max | 187.6 | 190.1 | 187 | 185.8 | 190.6 |
| Flash point, ° C. | D56 | 38 | min | 43.0 | 45.0 | 38.5 | 38.0 | 38.0 |
| Density, kg/m3 at 15° C. | D4052 | 730-770 | | 731.2 | 731.7 | 731.9 | | |
| Freezing point, ° C. | D2386 | −40 | min | −50.9 | −60.5 | −56.2 | | |
| Existent gum, mg/100 mL | IP 540 | 7 | max | 58 | 40 | 10 | 12 | 10 |

As shown in Table 2, at least 90 vol. % of the LPK boils within the target 150-180° C. associated for superior low temperature jet engine ignition properties. Although on the lighter end of the volatility specification limits, the LPK fraction conformed to specifications. In fact, the LPK fraction was found to conform to all ASTM D7566 HEFA SAF specifications with the exception of existent gum (discussed in Example 2 below).

### Example 2. Investigation of “Gum” Residue from Existent Gum Tests

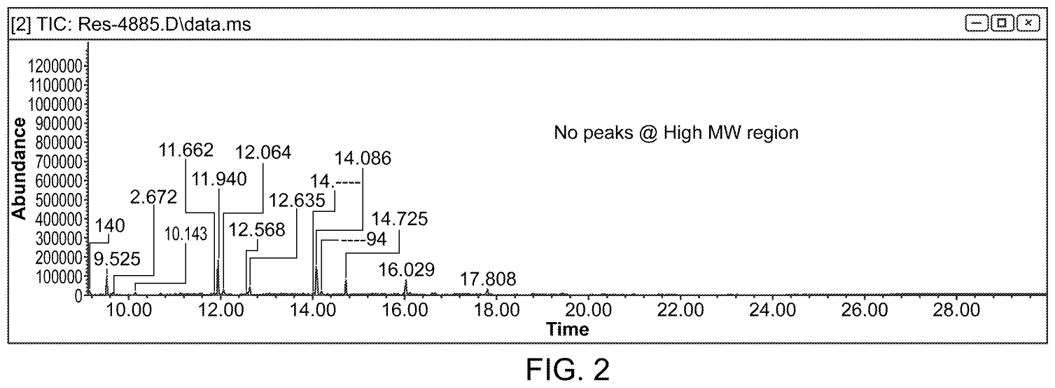

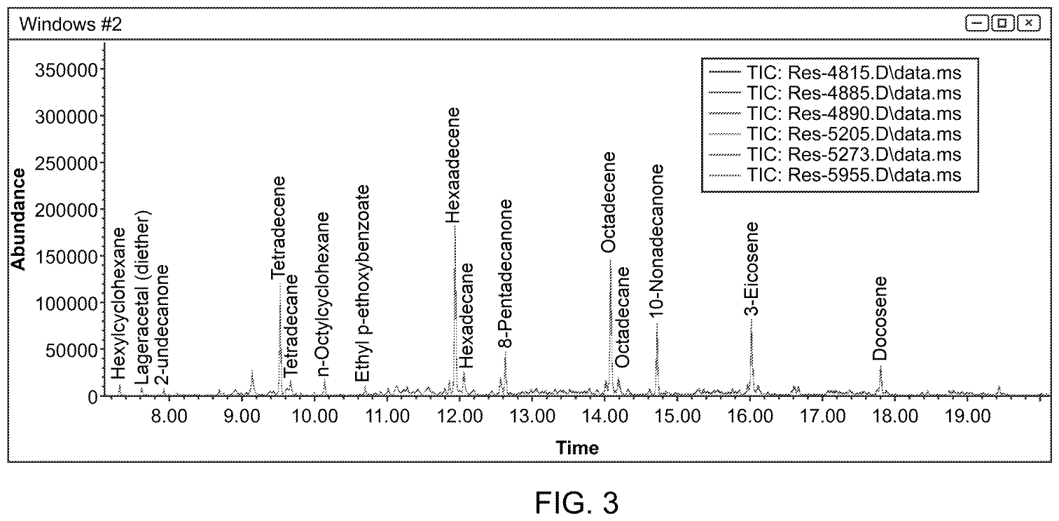

The residues left in seven test tubes after stripping the LPK of Example 1 according to standardized test method IP540 air evaporation method were analyzed via GC-MS (GC with mass spectrometer detector) to identify the composition of the “gum” residues. The art-based expectation was that these would be polymeric material (molecular weight>C₂₄). However the tests showed no “heavies” or polymerized material in these gum residues (FIG. 2), but instead contained mainly tetradecane (C₁₄), hexadecane (C₁₆), and octadecane (C₁₈), and other C₁₄-C₂₂ hydrocarbons as observed from FIG. 3 chromatogram. FIG. 3 is a GC overlay from all seven “gum” residues recovered from LPK existent gum test.

### Example 3. Cetane Number

A sample of the LPK produced according to the procedure described in Example 1 was submitted for cetane number test according to ASTM D613 test method. The cetane number for LPK was found to be 65.1, well above the target minimum cetane number (55) for mitigation of Lean Blow Out (LBO).

### Example 4. Effect of LPK Iso/Normal Ratio on Existent Gum Test Results

The diesel and the LPK fractions prepared according to conditions described in Example 1 were combined to produce broader boiling range HI products. In a first trial (Trial 1), the HI reactor was operated at the lower end of the 600-620° F. temperature range of Example 1 to minimize the hydrocracking side reactions. The diesel and the LPK fractions were combined to produce a broad boiling range HI product. The cloud point of this first HI product was found to be −11 C.

In a second trial (Trial 2), the HI reactor was operated at the upper end of the 600-620° F. temperature range to increase hydrocracking side reactions. The corresponding diesel and LPK fractions were combined. The cloud point of this second HI product was found to be −21 C.

The diesel fractions during both trials were tested for trace heteroatoms. No sulfur and nitrogen was detected (i.e. <0.5 ppm detection limit). The acid number was also below detection limit (<0.02 mg KOH/g).

The HI products from Trial 1 and Trial 2 were distilled to produce a SAF distillate comprising LPK. A 12 liter lab spinning band distillation system from BR Instruments (Model 9600) was used. The distillation system was configured with a perforated helical Teflon band designed to create about 50 theoretical trays. This unit was operated at approximately 100 mmHg vacuum. For these experiments, the reflux ratio was set to 5:1. Two distillates were obtained from each HI product and analyzed by GC simulated distillation for n-paraffin and iso-paraffin concentrations by carbon number (using GC area counts). Each SAF distillate sample was also analyzed for freezing point, and submitted for existent gum analysis by both the ASTM D381 (steam evaporation) and the IP 540 (air evaporation) methods. The results are summarized in Table 3.

TABLE 3
Distillation of HI Products and Properties of Corresponding SAF Distillates

| | | | | | SAF fractions | | | | |
|---|---|---|---|---|---|---|---|---|---|
| Distillation Conditions | | | SAF | | LPK (C8-C11) | | | SAF Existent Gum | |
| | Pot | Vapor | recovery | SAF Freeze | Content | | C13-C18 | IP 540 (Air | D381 (Steam |
| Pressure | Temp | Temp | % of starting | Point | GC peak | iso/normal | iso/normal | Method) | Method) |
| mmHg | ° C. | ° C. | HI Product | ° C. | area % | ratio | ratio | mg/100 mL | mg/100 mL |

HI Trial 1 Product Distillation

| | | | | | | | | | | |
|---|---|---|---|---|---|---|---|---|---|---|
| SAF Distillate 1 | 98 | 223.5 | <178 | 10.4% | <−50 | 47.0 | 1.1 | 5.0 | 4 | 3 |
| SAF Distillate 2 | 98 | 226.7 | <197 | 18.7% | −34 | 26.1 | 1.1 | 5.4 | 9 | 4 |

HI Trial 2 ProductDistillation

| | | | | | | | | | | |
|---|---|---|---|---|---|---|---|---|---|---|
| SAF Distillate 3 | 98 | 224.2 | <195 | 30.7% | <−50 | 35.0 | 3.6 | 4.9 | 2 | 2 |
| SAF Distillate 4 | 98 | 227 | <197 | 34.6% | −41 | 30.5 | 3.6 | 4.6 | 3 | 3 |

As observed in Table 3, the LPK fraction (C₈-C₁₁) of SAF distillates 1 and 2 had an iso/normal ratio of 1.1. These SAF distillates showed variability between the existent gum values as measured by the two standard test methods, and one of the two distillates failed the gum test using the IP 540 air evaporation method. Note that SAF Distillate 2 existent gum value of 9 mg/100 mL is above the specified maximum value of 7 mg/100 mL.

On the other hand, the LPK fraction of SAF distillates 3 and 4 had an iso/normal ratio of 3.6. These showed consistent conformance with the existent gum specification of 7 mg/100 mL maximum according to both test methods (ASTM D381 steam evaporation and IP 540 air evaporation). All SAF products with freezing point values below −40 C had at least 30 wt. % LPK content.

### Example 5. Effect of Residual C₁₄+ Paraffins on LPK Existent Gum Test Results

A sample of LPK was analyzed via GC and found to be 99.7% C₁₃ and lighter hydrocarbons, with an iso/normal ratio of 1.3. The C₁₄+(i.e., C₁₄ or heavier) hydrocarbons included 0.2% C₁₄-C₁₆ paraffins and 0.1% C₁₇-Cis paraffins. The existent gum for the LPK sample was measured according to IP 540 air method and was found to be 13 mg/100 mL.

The LPK was subjected to distillation via the spinning band distillation apparatus described in Example 4. The operating pressure for this set of distillation experiments was 50 mmHg. The resulting fractions, their composition according to GC analysis, and corresponding existent gum test results, are summarized in Table 4.

TABLE 4
Existent Gum Test Results of the Example 5 LPK Cuts, and Combination of Cuts

| | | Existent Gum | | | | | |
|---|---|---|---|---|---|---|---|
| | | by IP 540 air | Composition by GC Analysis | | | | |
| Cut No. or | Yield | method | Iso/normal | C₁₃ minus | C₁₄-C₁₆ | C₁₇-C₁₈ | C₁₈ plus |
| Blend | (wt. %) | (mg/100 mL) | ratio | (wt. %) | (wt. %) | (wt. %) | (wt. %) |
| LPK before | — | 13 | 1.3 | 99.7 | 0.2 | 0.1 | 0.0 |
| fractionation | | | | | | | |
| Cut 1 | 19.0 | 1 | 1.3 | 100.0 | 0.0 | 0.0 | 0.0 |
| Cut 2 | 36.0 | 1 | 1.0 | 100.0 | 0.0 | 0.0 | 0.0 |
| Cut 3 | 24.9 | 1 | 1.3 | 100.0 | 0.0 | 0.0 | 0.0 |
| Cuts 1 and 2 | 55.0 | 1 | 1.1 | 100.0 | 0.0 | 0.0 | 0.0 |
| blended | | | | | | | |
| Cuts 1, 2, and | 79.9 | 1 | 1.1 | 100.0 | 0.0 | 0.0 | 0.0 |
| 3 blended | | | | | | | |
| Bottoms | 20.1 | 172 | 2.0 | 97.8 | 1.2 | 0.7 | 0.4 |
| Cuts 1-3 and | — | 11 | 1.2 | 99.9 | 0.1 | 0.0 | 0.0 |
| bottoms | | | | | | | |
| blended | | | | | | | |

### Example 6

LPK was produced according to the method and conditions described in Example 1, with the exception that higher HI reactor temperatures in the range of 626° F. to 635° F. (about 330° C. to about 335° C.) were utilized to provide more hydrocracking and raise the iso/normal ratio from about 1 to about 2. Three different LPK samples were collected, differing in the fractionation conditions. The results are summarized in Table 5 below. Notably, the presence of “C₁₄ plus” affects the existent gum test results of the LPK product according to the ASTM D381 steam method.

TABLE 5

| | Existent Gum | | | | | |
|---|---|---|---|---|---|---|
| | (ASTM D381 | | | | | |
| | steam | Iso/ | C₁₃ | C₁₄- | C₁₇- | “C₁₈ |
| Sample | method; | normal | minus | C₁₆ | C₁₈ | plus” |
| No. | mg/100 mL) | Ratio | (wt. %) | (wt. %) | (wt. %) | (wt. %) |
| 1 | 2 | 1.9 | 100.0 | 0.0 | 0.0 | 0.0 |
| 2 | 6 | 2.0 | 99.7 | 0.1 | 0.2 | 0.0 |
| 3 | 7 | 2.0 | 99.5 | 0.2 | 0.3 | 0.0 |

While certain embodiments have been illustrated and described, it should be understood that changes and modifications can be made therein in accordance with ordinary skill in the art without departing from the technology in its broader aspects as defined in the following claims. Each aspect and embodiment described above can also have included or incorporated therewith such variations or aspects as disclosed in regard to any or all of the other aspects and embodiments.

The present technology is also not to be limited in terms of the particular aspects and/or embodiments described herein, which are intended as single illustrations of individual aspects and/or embodiments of the present technology. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

The embodiments, illustratively described herein, may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

The present technology may include, but is not limited to, the features and combinations of features recited in the following lettered paragraphs, it being understood that the following paragraphs should not be interpreted as limiting the scope of the claims as appended hereto or mandating that all such features must necessarily be included in such
A. A method for producing a light paraffinic kerosene (LPK), the method comprising
   hydrotreating a biorenewable feedstock comprising C₁₄-C₂₄ fatty acids, fatty acid esters, and/or fatty acid glycerides to yield a heavy hydrotreater fraction comprising C₁₄-C₂₄ n-paraffins;
   hydroisomerizing and hydrocracking the heavy hydrotreater fraction with a hydroisomerization catalyst under conditions yielding a hydroisomerizer product comprising a heavy hydroisomerizer fraction and the LPK, the LPK comprising C₈-C₁₁ hydrocarbons; and
   separating the LPK from the hydroisomerizer product;
   wherein the LPK has an existent gum value of 7 mg/100 mL or less as measured according to IP 540 air evaporation method and comprises:
      a weight ratio of isoparaffins to n-paraffins of about 2:1 or greater, or
      no detectable hydrocarbons with 14 or more carbon atoms as measured by gas chromatography, or
      a weight ratio of isoparaffins to n-paraffins of about 2:1 or greater and no detectable hydrocarbons with 14 or more carbon atoms as measured by gas chromatography.
B. The method of Paragraph A, the method comprising hydroisomerizing and hydrocracking the heavy hydrotreater fraction at a temperature of about 580° F. to about 750° F., optionally at a temperature of about 626° F. to about 635° F.
C. The method of Paragraph A or Paragraph B, wherein the ratio of isoparaffins to n-paraffins of the LPK is about 2:1 to about 5:1.
D. The method of any one of Paragraphs A-C, wherein the ratio of isoparaffins to n-paraffins of the LPK is about 3:1 to about 4:1.
E. The method of any one of Paragraphs A-D, further comprising separating a renewable diesel from the hydroisomerizer product, the renewable diesel comprising the heavy hydroisomerizer fraction.
F. The method of any one of Paragraphs A-E, wherein the biorenewable feedstock comprises used cooking oil, rendered fats, or a combination thereof.
G. The method of any one of Paragraphs A-F, wherein the biorenewable feedstock comprises carinata oil, field pennycress oil, a flowering plant oil, or a combination of any two or more thereof.
H. The method of any one of Paragraphs A-G, wherein the LPK has a flash point of about 38° C. to about 42° C.
I. The method of any one of Paragraphs A-H, wherein the LPK has a cetane number of about 55 to about 80.
J. The method of any one of Paragraphs A-I, wherein the LPK comprises about 99.9 wt. % or greater of hydrocarbons with less than 14 carbon atoms.
K. A method for producing a biorenewable sustainable aviation fuel (SAF), the method comprising
   hydrotreating a biorenewable feedstock comprising C₁₄-C₂₄ fatty acids, fatty acid esters, and/or fatty acid glycerides to yield a heavy hydrotreater fraction comprising C₁₄-C₂₄ n-paraffins;
   hydroisomerizing and hydrocracking the heavy hydrotreater fraction with a hydroisomerization catalyst under conditions yielding a hydroisomerizer product comprising a heavy hydroisomerizer fraction and a light paraffinic kerosene (LPK), the LPK comprising C₈-C₁₁ hydrocarbons;
   separating a sustainable aviation fuel (SAF) from the hydroisomerizer product;
wherein
   the SAF comprises at least a portion of the LPK
   the LPK has an existent gum value of 7 mg/100 mL or less as measured according to IP 540 air evaporation method and comprises:
      a weight ratio of isoparaffins to n-paraffins of about 2:1 or greater, or
      no detectable hydrocarbons with 14 or more carbon atoms as measured by gas chromatography, or
      a weight ratio of isoparaffins to n-paraffins of about 2:1 or greater and no detectable hydrocarbons with 14 or more carbon atoms as measured by gas chromatography; and
   the SAF has an existent gum value of 7 mg/100 mL or less as measured according to IP 540 air evaporation method.
L. The method of Paragraph K, wherein the separating is performed to provide a SAF comprising about 30 wt. % or greater of the LPK.
M. The method of Paragraph K or Paragraph L, wherein the SAF comprises about 30 wt. % to about 90 wt. % of the LPK.
N. The method of any one of Paragraphs K-M, wherein the SAF further comprises C₁₂-C₁₆ isoparaffins.
O. The method of any one of Paragraphs K-N, comprising hydroisomerizing and hydrocracking the heavy hydrotreater fraction at a temperature of about 580° F. to about 750° F.
P. The method of any one of Paragraphs K-O, wherein the ratio of isoparaffins to n-paraffins of the LPK is about 2:1 to about 5:1.
Q. The method of any one of Paragraphs K-P, wherein the ratio of isoparaffins to n-paraffins of the LPK is about 3:1 to about 4:1.
R. The method of any one of Paragraphs K-Q, further comprising separating a renewable diesel from the hydroisomerizer product, the renewable diesel comprising the heavy hydroisomerizer fraction.
S. The method of any one of Paragraphs K-R, wherein the biorenewable feedstock comprises used cooking oil, rendered fats, or a combination thereof.
T. The method of any one of Paragraphs K-S, wherein the biorenewable feedstock comprises carinata oil, field pennycress oil, a flowering plant oil, or a combination of any two or more thereof.
U. The method of any one of Paragraphs K-T, wherein the LPK has a flash point of about 38° C. to about 42° C.
V. The method of any one of Paragraphs K-U, wherein the LPK has a cetane number of about 55 to about 80.
W. The method of any one of Paragraphs K-V, wherein the LPK comprises about 99.9 wt. % or greater of hydrocarbons with less than 14 carbon atoms.
X. A method of producing a sustainable aviation fuel (SAF), the method comprising combining C₁₂-C₁₆ isoparaffins with an LPK produced by the method of any one of Paragraphs A-J.
Y. A sustainable aviation fuel (SAF) produced according to the method of Paragraph X.
Z. A sustainable aviation fuel (SAF) comprising
   C₁₂-C₁₆ isoparaffins; and
   a light paraffinic kerosene (LPK) produced according to a method of any one of Paragraphs A-J.
AA. A biorenewable sustainable aviation fuel (SAF) produced according to a method of any one of Paragraphs K-W.
Other embodiments are set forth in the following claims.

1. A method for producing a light paraffinic kerosene (LPK), the method comprising
hydrotreating a biorenewable feedstock comprising C₁₄-C₂₄ fatty acids, fatty acid esters, and/or fatty acid glycerides to yield a heavy hydrotreater fraction comprising C₁₄-C₂₄ n-paraffins;
hydroisomerizing and hydrocracking the heavy hydrotreater fraction with a hydroisomerization catalyst under conditions yielding a hydroisomerizer product comprising a heavy hydroisomerizer fraction and the LPK, the LPK comprising C₈-C₁₁ hydrocarbons; and
separating the LPK from the hydroisomerizer product;
wherein the LPK has an existent gum value of 7 mg/100 mL or less as measured according to IP 540 air evaporation method and comprises:
a weight ratio of isoparaffins to n-paraffins of about 2:1 or greater, or
no detectable hydrocarbons with 14 or more carbon atoms as measured by gas chromatography, or
a weight ratio of isoparaffins to n-paraffins of about 2:1 or greater and no detectable hydrocarbons with 14 or more carbon atoms as measured by gas chromatography.

2. The method of claim 1, the method comprising hydroisomerizing and hydrocracking the heavy hydrotreater fraction at a temperature of about 580° F. to about 750° F.

3. The method of claim 1, wherein the ratio of isoparaffins to n-paraffins of the LPK is about 2:1 to about 5:1.

4. (canceled)

5. The method of claim 1, further comprising
separating a renewable diesel from the hydroisomerizer product, the renewable diesel comprising the heavy hydroisomerizer fraction.

6. (canceled)

7. The method of claim 1, wherein the biorenewable feedstock comprises carinata oil, field pennycress oil, a flowering plant oil, or a combination of any two or more thereof.

8. The method of claim 1, wherein the LPK has a flash point of about 38° C. to about 42° C.

9. The method of claim 1, wherein the LPK has a cetane number of about 55 to about 80.

10. The method of claim 1, wherein the LPK comprises about 99.9 wt. % hydrocarbons with less than 14 carbon atoms.

11. A method for producing a biorenewable sustainable aviation fuel (SAF), the method comprising
hydrotreating a biorenewable feedstock comprising C₁₄-C₂₄ fatty acids, fatty acid esters, and/or fatty acid glycerides to yield a heavy hydrotreater fraction comprising C₁₄-C₂₄ n-paraffins;
hydroisomerizing and hydrocracking the heavy hydrotreater fraction with a hydroisomerization catalyst under conditions yielding a hydroisomerizer product comprising a heavy hydroisomerizer fraction and a light paraffinic kerosene (LPK), the LPK comprising C₈-C₁₁ hydrocarbons;
separating a sustainable aviation fuel (SAF) from the hydroisomerizer product;
wherein
the SAF comprises at least a portion of the LPK
the LPK has an existent gum value of 7 mg/100 mL or less as measured according to IP 540 air evaporation method and comprises:
a weight ratio of isoparaffins to n-paraffins of about 2:1 or greater, or
no detectable hydrocarbons with 14 or more carbon atoms as measured by gas chromatography, or
a weight ratio of isoparaffins to n-paraffins of about 2:1 or greater and no detectable hydrocarbons with 14 or more carbon atoms as measured by gas chromatography; and
the SAF has an existent gum value of 7 mg/100 mL or less as measured according to IP 540 air evaporation method.

12. The method of claim 11, wherein the separating is performed to provide a SAF comprising about 30 wt. % or greater of the LPK.

13. The method of claim 11, wherein the SAF comprises about 30 wt. % to about 90 wt. % of the LPK.

14. The method of claim 11, wherein the SAF further comprises C₁₂-C₁₆ isoparaffins.

15. The method of claim 11, comprising hydroisomerizing and hydrocracking the heavy hydrotreater fraction at a temperature of about 580° F. to about 750° F.

16. The method of claim 11, wherein the ratio of isoparaffins to n-paraffins of the LPK is about 2:1 to about 5:1.

17. (canceled)

18. The method of claim 11, further comprising separating a renewable diesel from the hydroisomerizer product, the renewable diesel comprising the heavy hydroisomerizer fraction.

19. (canceled)

20. The method of claim 11, wherein the biorenewable feedstock comprises carinata oil, field pennycress oil, a flowering plant oil, or a combination of any two or more thereof.

21.-23. (canceled)

24. A method of producing a sustainable aviation fuel (SAF), the method comprising combining C₁₂-C₁₆ isoparaffins with an LPK produced by the method of claim 1.

25. A sustainable aviation fuel (SAF) produced according to the method of claim 24.

26. A sustainable aviation fuel (SAF) comprising
C₁₂-C₁₆ isoparaffins; and
a light paraffinic kerosene (LPK) produced according to a method of claim 1.

27. A biorenewable sustainable aviation fuel (SAF) produced according to a method of claim 11.
